(19) United States
(12) Patent Application Publication
(10) Pub. No.: US 2026/0160483 A1
(43) Pub. Date: Jun. 11, 2026

(54) AUTOMATED DOOR CONTROL SYSTEM FOR REFRIGERATED PRODUCT STORAGE

(71) Applicants: Shahan Ohanessian, Glendale, CA (US); Shoushana Ohanessian, Glendale, CA (US)

(72) Inventors: Shahan Ohanessian, Glendale, CA (US); Shoushana Ohanessian, Glendale, CA (US)

(21) Appl. No.: 19/183,272

(22) Filed: Apr. 18, 2025

Related U.S. Application Data
(60) Provisional application No. 63/636,730, filed on Apr. 20, 2024.

(51) Int. Cl. F25D 23/02; F25D 29/00

(52) U.S. Cl. CPC F25D 23/021; F25D 29/006; F25D 2700/02

(57) ABSTRACT

An automated door control system for refrigerated product storage enables precise, coordinated movement of multiple sliding doors. The system comprises a refrigerated storage cabinet with multiple sliding doors, door opening mechanisms for each door, and an integrated control unit that coordinates door movements. Each door opening mechanism features a linear guide system with integrated position sensing capabilities, employing phototransistor switches positioned at specific points along the linear guide to precisely control door positions. The system provides autonomous operation without human intervention, precise door position control, reliable state verification through contactless sensing, and enhanced system longevity through reduced mechanical wear.

### CROSS-REFERENCE TO RELATED APPLICATIONS

This application claims the benefit of U.S. Provisional Application No. 63/636,730 titled “SyncFridge: Smart Synchronized Refrigerator System for Seamless Item Retrieval,” filed on Apr. 20, 2024, the specification of which is incorporated herein by reference in its entirety.

### FIELD OF THE INVENTION

This invention relates generally to automated refrigeration systems, and more particularly to mechanisms for controlling multiple sliding doors in refrigerated product storage systems used within automated retail environments.

### BACKGROUND OF THE INVENTION

The field of refrigeration technology continues to evolve to meet the changing needs of retail environments. Traditional retail refrigeration systems require manual operation of doors for product access and retrieval. This manual operation presents several challenges in modern retail settings. The frequent opening and closing of refrigerator doors leads to inefficiencies in product retrieval workflows and can cause temperature fluctuations that potentially affect product quality and energy consumption. In automated retail environments, where human interaction is minimized or eliminated, there is a growing need for systems that can precisely control access to refrigerated products while maintaining optimal storage conditions.

The retail industry has seen various technological advances in refrigeration systems. Recent developments have focused primarily on inventory management systems and product monitoring capabilities within refrigerated spaces. These solutions typically emphasize tracking product placement, monitoring storage conditions, and managing inventory levels through various sensing technologies.

However, existing solutions have not adequately addressed the mechanical challenges associated with automated door control in retail settings. The precise coordination of multiple sliding doors, while maintaining proper temperature conditions and enabling efficient product retrieval, presents unique engineering challenges that require innovative solutions.

Additionally, traditional refrigeration systems in retail environments often require protective measures such as disposable sleeves or bags to maintain hygiene during manual door operation. The need for such additional materials increases operational costs and environmental impact.

The integration of refrigeration systems into automated retail environments introduces new requirements for precise control and coordination between storage access and robotic retrieval systems. These requirements necessitate novel approaches to door control mechanisms that can operate reliably while minimizing temperature fluctuations and energy consumption.

### SUMMARY OF THE INVENTION

In accordance with certain aspects of a preferred embodiment, an automated door control system for refrigerated product storage is provided that enables precise, coordinated movement of multiple sliding doors within an automated retail environment. The system comprises a refrigerated storage cabinet with multiple sliding doors mounted on tracks, individual door opening mechanisms for each door, and an integrated control unit that coordinates door movements.

In one aspect, the invention includes a door opening mechanism featuring a linear guide system carrying a screw drive operated by a motor. The mechanism employs strategically positioned photometric switches affixed to the linear guide and a switch breaker attached to a door mounting carriage bracket to precisely control and verify door positions.

The system defines and maintains two primary door states-Open and Closed. The Open state is achieved when the sliding door reaches its maximum open position, with the distance between the operating sliding door and adjacent door being minimized. The Closed state is achieved when the sliding door returns to its fully closed position, with the distance between the operating sliding door and adjacent door being maximized. Position verification is provided through engagement between the photometric switches and switch breakers.

The door opening mechanisms are mounted in an alternating configuration between the front side and back side of the refrigerated cabinet's front wall, enabling the sliding doors to move smoothly in front of and behind one another during operation. This configuration, combined with the precise control provided by the photometric switches and switch breakers, ensures reliable and efficient door operation while maintaining optimal temperature conditions within the refrigerated space.

The invention provides several significant advantages over existing solutions, including autonomous operation without human intervention, precise door position control through contactless sensing, enhanced system longevity through reduced mechanical wear, and synchronized operation with robotic product retrieval systems. The system is particularly suited for integration into automated retail environments where maintaining consistent temperature conditions and enabling efficient product access are essential.

Still other aspects, features and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized. The present invention is illustrated by way of example, and not by way of limitation, in the figures of the accompanying drawings, in which like reference numerals refer to similar elements, and in which:

FIG. 1 is a front view of an automated retail system incorporating automated door control systems for refrigerated product storage according to certain aspects of an embodiment of the invention.

FIG. 2 is a front view of a refrigeration unit incorporating an automated door control system according to certain aspects of an embodiment of the invention.

FIG. 3 is a perspective view of the refrigeration unit of FIG. 2.

FIG. 4 is a top, cross-sectional view of the refrigeration unit of FIG. 2 along section line A-A.

FIG. 5 is a front view of a door opening mechanism for use in the automated door control system according to certain aspects of an embodiment of the invention.

FIG. 6 is a perspective view of the door opening mechanism of FIG. 5.

FIG. 7 is a left side view of the door opening mechanism of FIG. 5.

FIG. 8 is a right side view of the door opening mechanism of FIG. 5.

FIG. 9 is a front view of the refrigeration unit of FIG. 2 showing one sliding door in an open state.

FIG. 10 is a perspective view of the refrigeration unit of FIG. 2 showing one sliding door in an open state.

### DETAILED DESCRIPTION OF THE PREFERRED EMBODIMENTS

The invention may be understood by referring to the following description and accompanying drawings. This description of an embodiment, set out below to enable one to practice an implementation of the invention, is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Descriptions of well-known functions and structures are omitted to enhance clarity and conciseness. The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item.

The use of the terms “first”, “second”, and the like does not imply any particular order, but they are included to identify individual elements. Moreover, the use of the terms first, second, etc. does not denote any order of importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Although some features may be described with respect to individual exemplary embodiments, aspects need not be limited thereto such that features from one or more exemplary embodiments may be combinable with other features from one or more exemplary embodiments.

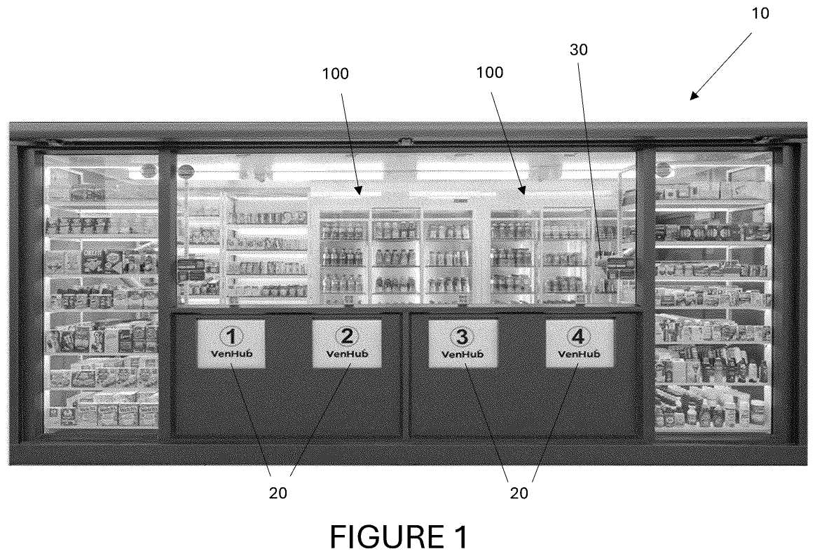

In accordance with certain aspects of an embodiment of the invention, an automated door control system is provided. In an exemplary configuration, the system may be used for controlling the opening and closing of doors on a refrigeration unit 100 storing refrigerated products intended for automated product selection and delivery in an automated retail system 10, such as that shown in FIG. 1, which automated retail system 10 may enable the automated retail purchasing, retrieval, and secure pickup and distribution of refrigerated products without requiring human interaction. As shown in FIG. 1, the automated retail system 10 may offer purchasers a variety of products available for vending through secure pickup windows 20, with preferably both refrigerated and non-refrigerated product storage within the automated retail system 10 as described in detail below. Automated retail system 10 may be equipped with one or more robotic arms 30 capable of retrieving the stored products inside of automated retail system 10. While refrigerated products are stored inside of closed refrigeration units 100, upon processing of a consumer's order for a refrigerated product, the automated retail system 10 signals a controller on the refrigeration unit to automatically open at least one of multiple doors on the refrigeration unit to allow the robotic arm 30 to easily access and remove the ordered refrigerated product from the refrigeration unit 100. Automated movement of the doors on the refrigeration unit 100 is preferably synchronized to movement of the robotic arm 30 to ensure that the door is open only for the minimum amount of time necessary to enable the robotic arm 30 to secure and remove the ordered refrigerated item, thus minimizing temperature fluctuations and energy usage. After the refrigerated product has been removed, the controller automatically closes the opened door or doors of the refrigeration unit 100, and the robotic arm preferably moves the purchased product toward one of the secure pickup windows 20 for ultimate retrieval by an authorized customer.

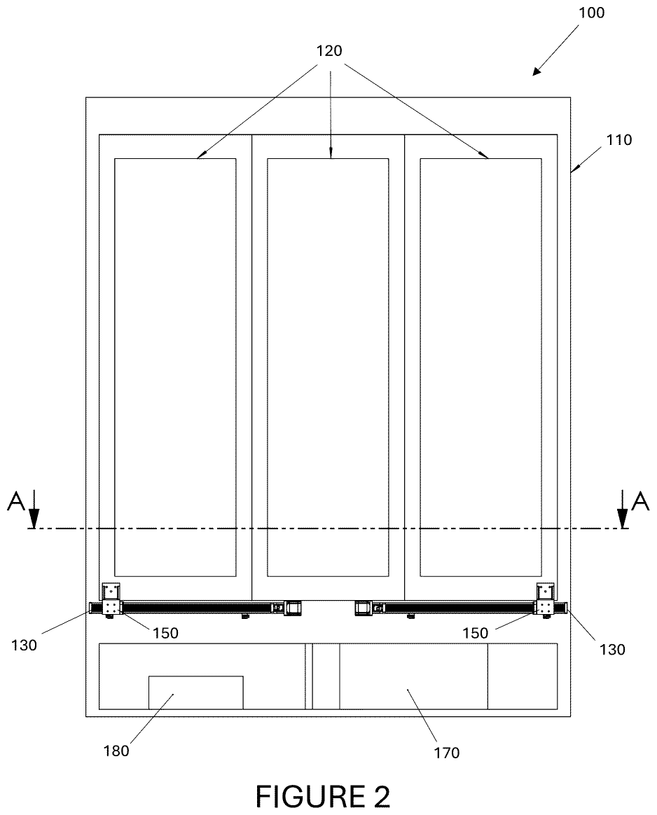

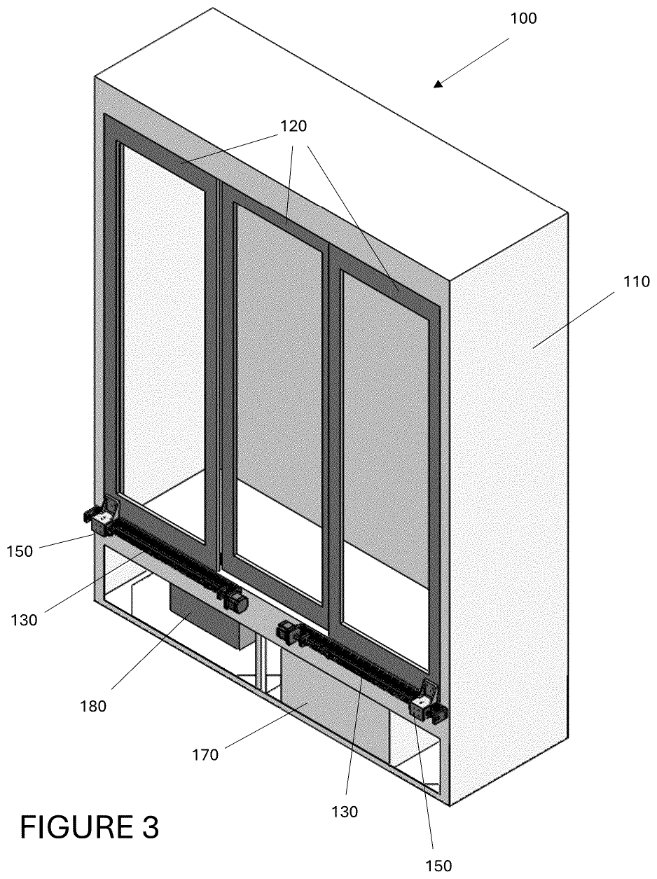

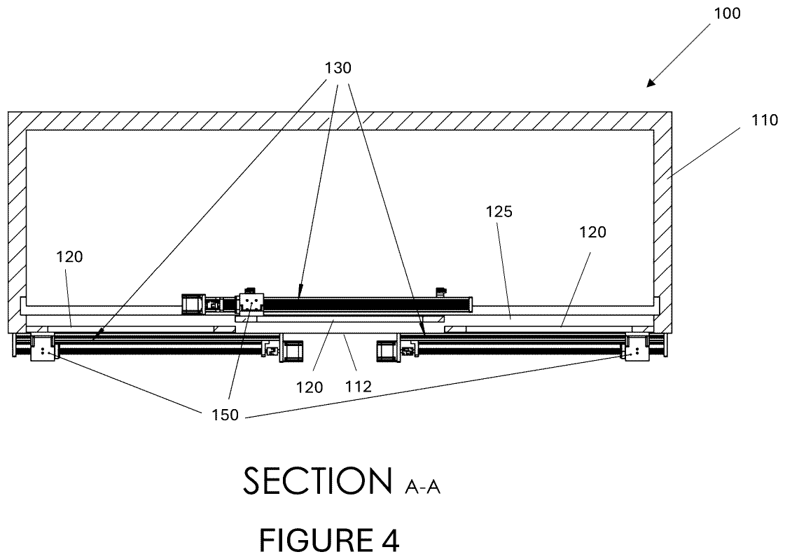

In accordance with certain aspects of a particularly preferred embodiment, FIGS. 2 and 3 show a refrigeration unit 100 configured for placement inside of automated retail system 10. Each refrigeration unit 100 comprises a generally rectangular metallic frame 110 that houses the refrigerated storage space, and multiple sliding doors 120 at the front of the refrigeration unit 100. Sliding doors are mounted on sliding door track 125 (FIG. 4) for ease of opening and closing when needed to access refrigerated product inside of refrigeration unit 100. A compressor 170 of standard configuration is housed inside of frame 110, along with a controller 180 that (as discussed further below) is configured to automatically open and close sliding doors 120.

To open sliding doors 120, a door opening mechanism 130 is joined to each sliding door 120. As best viewed in the top cross-sectional view of refrigeration unit 100 of FIG. 4, in a refrigeration unit 100 equipped with, for example, three sliding glass doors 120, the sliding glass doors 120 are positioned intermittently spaced from one another from front to back on sliding door track 125 to enable immediately adjacent sliding doors 120 to slide in front of and behind one another. Door opening mechanisms 130 are thus intermittently affixed to the frame 110 of refrigeration unit 100 alternating between a front side and a back side of a front wall 112 of refrigeration unit 100.

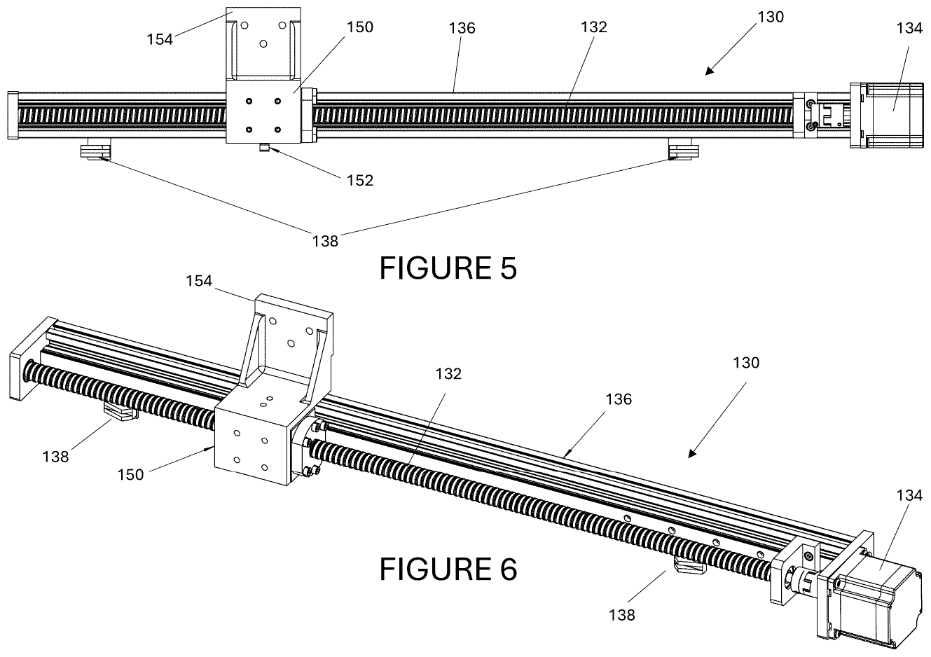

With reference to FIGS. 5 and 6, each door opening mechanism 130 includes a linear guide 136 that carries a screw drive 132 driven by a motor 134, such as an electric motor. A door mounting carriage bracket 150 is carried by linear screw drive 132 to travel horizontally along screw drive 132 across linear guide 136. Each door mounting carriage bracket 150 is affixed to a bottom portion of a single one of sliding doors 120 via suitable fasteners, such as screws, bolts, or similar fastening devices. A switch breaker 152 is attached at the bottom of each door mounting carriage bracket 150, and at least two photometric switches 138 are affixed to the bottom of each linear guide 136 and positioned to engage the switch breaker 152 on the bottom of the associated door mounting carriage bracket 150. One photometric switch 138 is positioned to engage switch breaker 152 on the bottom of the associated door mounting carriage bracket 150 when its sliding door 120 is in a fully closed position, and the another photometric switch 138 is positioned to engage switch breaker 152 when its sliding door 120 is in a fully open position. In this configuration, controller may sense through photometric switches 138 when a sliding door is in a fully open or fully closed positioned, and thus may operate door opening mechanism 130 to open and close a sliding door 120 as and when required.

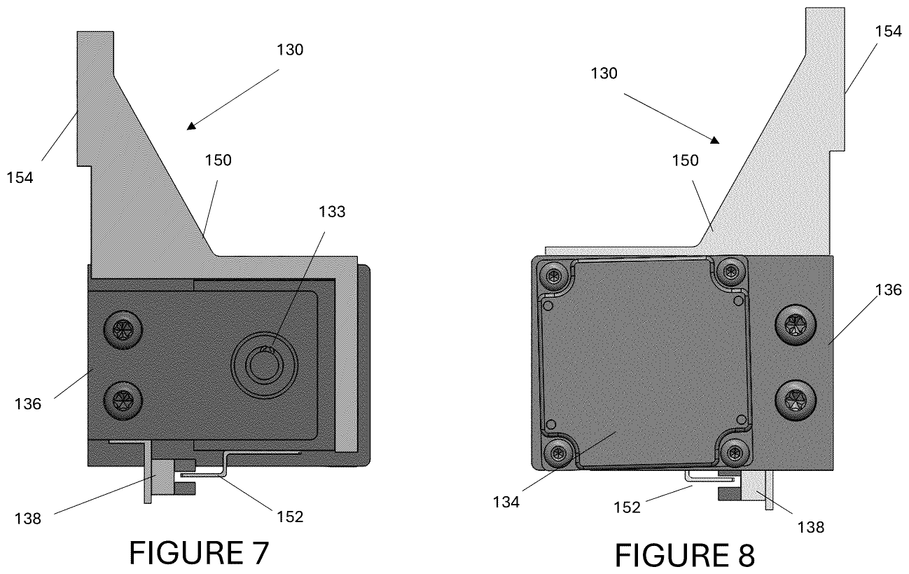

FIGS. 7 and 8 provide detailed left and right views, respectively of door opening mechanism 130. As shown in those views, door mounting carriage bracket 150 includes an upstanding attachment arm 154 for attachment to the bottom portion of a sliding door 120 on refrigeration unit 100. Door mounting carriage bracket 150 rides along linear guide 136 to open and close sliding door 120, and particularly along screw drive 132 (FIGS. 5 and 6) that is rotatably mounted at one end to screw drive receiver 133, and is drivingly engaged with motor 134 at the opposite end of door opening mechanism 130. Each photometric switch 138 is mounted to linear guide 136 so that it extends downward from the bottom of linear guide 136, and generally Z-shaped switch breaker 152 is mounted to the bottom of door mounting carriage bracket 150 and positioned to engage photometric switch 138 to signal to controller the arrival of the attached sliding door 120 at a designated open or closed position.

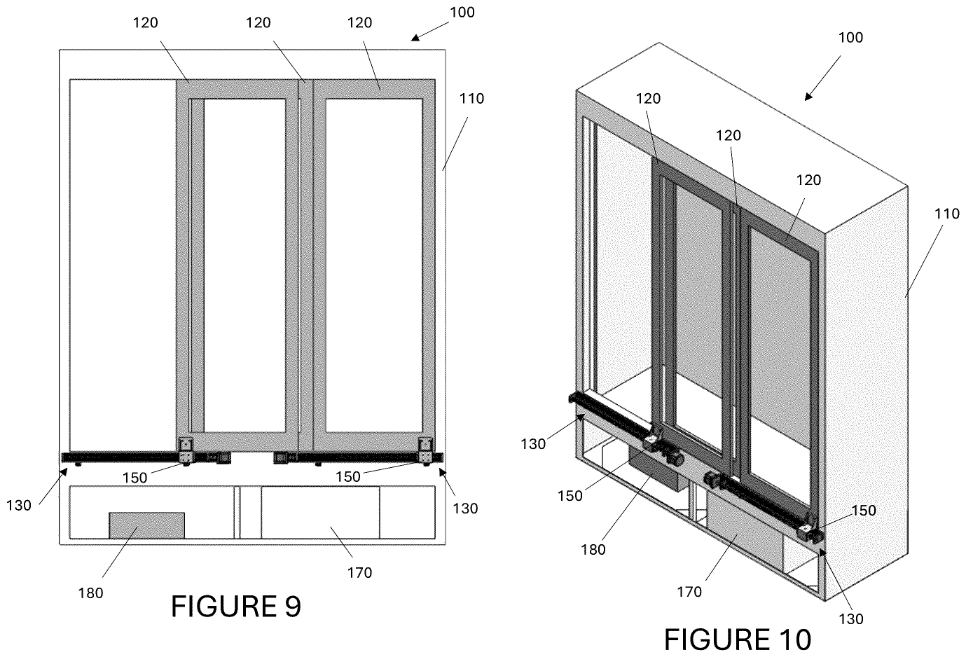

As shown in FIGS. 9 and 10, the mounting configuration of sliding doors 120 on refrigeration unit 100 and the operation of each door opening mechanism 130 enable the remote, automated opening of a sliding door 120 through movement of door mounting carriage bracket 150 along linear guide 136 to the fully open position shown in FIGS. 9 and 10 (coinciding with the location of one of photometric switches 138), and the reverse movement back to a fully closed position, through smooth, controlled movement and without interference with or from the other sliding doors 120 on refrigeration unit 100.

As mentioned above, controller 180 coordinates the movement of sliding doors 120 through precise actuation of door opening mechanisms 130. In this regard, when a door movement is initiated, the system (i) activates the appropriate linear guide motor 134; (ii) monitors door position through communication between controller 180 and phototransistor switches 138, and (iii) achieves precise positioning through engagement of switch breakers 152 with photometric switches 138. In such operations, controller 180 manages movement of sliding doors 120 particularly between a closed state and an open state. More particularly, controller 180 recognizes that a “door open” state has been achieved when sliding door 120 reaches its maximum open position, the distance between the operating sliding door 120 and the adjacent sliding door is minimized, and the bema of the corresponding photometric switch 138 is broken. Likewise, controller 180 recognizes that a “door closed” state has been achieved when the sliding door 120 returns to its fully closed position, the distance between the operating sliding door 120 and adjacent sliding door is maximized, and the beam of the corresponding photometric switch is broken.

Controller 180 is specifically programmed to coordinate multiple door movements in conjunction with robotic product retrieval operations. When processing a product retrieval request, the controller 180 executes the following sequence:
(i) Upon receiving a signal indicating a refrigerated product is to be retrieved, the controller 180 identifies which sliding door 120 must be opened to access the product;
(ii) The controller 180 verifies the current positions of all sliding doors 120 through the photometric switches 138 to ensure no mechanical conflicts will occur during door movement;
(iii) The controller 180 activates the appropriate door opening mechanism 130 by engaging its motor 134 to drive the screw drive 132;
(iv) The controller 180 monitors door movement through continuous communication with the photometric switches 138 until the switch breaker 152 indicates achievement of the fully open position;
(v) Once the sliding door 120 is verified as fully open, the controller 180 signals that product retrieval by robotic arm 30 may proceed;
(vi) After receiving confirmation that product retrieval is complete, the controller 180 reverses the motor 134 to return the sliding door 120 to its closed position, again monitoring movement through the photometric switches 138 until closure is verified.

Controller 180 is preferably further programmed to optimize door movements when multiple products must be retrieved. In such cases, the controller 180 analyzes the location of all requested products and determines the most efficient sequence of door operations to minimize temperature fluctuations and system wear. Controller 180 coordinates these door movements with the movements of robotic arm 30 to ensure doors remain open only for the minimum time necessary for product retrieval.

In the event that a photometric switch 138 fails to detect an expected switch breaker 152 engagement, the controller 180 is preferably programmed to halt door movement and signal an error condition. This failsafe programming prevents potential mechanical conflicts between adjacent sliding doors 120 and protects the integrity of stored products.

Systems configured in accordance with aspects of the invention may provide one or more of the following advantages over existing solutions. First, such systems offer autonomous refrigeration unit operation without human intervention. Second, such systems may offer precise control of the position of sliding doors without human intervention. Third, such systems may provide reliable state verification (i.e., door open or door closed states) through contactless sensing without requiring human intervention or confirmation. Fourth, such systems may offer enhanced system longevity through reduced mechanical wear.

Systems configured in accordance with certain aspects of the invention may employ intelligent door sequencing capabilities that provide significant additional advantages over conventional systems. The controller's ability to analyze multiple product locations and determine optimal door movement sequences maximizes operational efficiency while minimizing temperature fluctuations within the refrigerated space. This sophisticated coordination between door movements and robotic retrieval operations ensures minimal exposure time of refrigerated products to ambient temperatures.

Furthermore, such systems'integrated failsafe programming may provide enhanced reliability and product protection compared to conventional systems. The continuous position verification through photometric switches prevents potential mechanical conflicts between adjacent doors, while the automatic error detection and shutdown features protect both the mechanical components and stored products from damage. This intelligent error handling significantly reduces maintenance requirements and extends system longevity.

Even further, such systems'combination of precise position control, intelligent movement sequencing, and robust failsafe features enables truly autonomous operation in automated retail environments-a significant advancement over conventional systems requiring human oversight or intervention.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. Thus, it should be understood, therefore, that the invention may be practiced otherwise than as specifically set forth herein.

What is claimed is:

1. An automated door control system for refrigerated product storage, comprising:
a refrigerated storage cabinet having a frame and multiple sliding doors mounted on tracks within the frame;
a plurality of door opening mechanisms, each door opening mechanism joined to one of the sliding doors and comprising:
a linear guide carrying a screw drive;
a motor operatively connected to drive the screw drive;
a door mounting carriage bracket carried by the screw drive and attached to one of the sliding doors;
at least two photometric switches affixed to the linear guide; and
a switch breaker attached to the door mounting carriage bracket and positioned to engage the photometric switches; and
a controller configured to coordinate movement of the sliding doors through operation of the door opening mechanisms.

2. The system of claim 1, wherein the controller is further configured to:
verify current positions of all sliding doors through the photometric switches prior to initiating door movement;
monitor door movement through continuous communication with the photometric switches; and
halt door movement and signal an error condition if expected switch breaker engagement is not detected.

3. The system of claim 1, wherein the photometric switches are positioned to engage the switch breaker when the attached sliding door is in a fully open position and a fully closed position.

4. The system of claim 1, wherein the door opening mechanisms are mounted alternating between a front side and a back side of a front wall of the refrigerated storage cabinet.

5. The system of claim 2, wherein the controller is further configured to:
analyze locations of multiple products;
determine an efficient sequence of door operations to minimize temperature fluctuations; and
coordinate door movements with robotic arm movements to minimize door open time.

6. The system of claim 2, wherein the controller is further configured to:
receive a product retrieval signal;
identify which sliding door must be opened;
verify positions of all sliding doors to prevent mechanical conflicts;
monitor door movement until achieving verified fully open position;
signal authorization for product retrieval; and
return the sliding door to closed position after confirming retrieval completion.

7. A method of controlling sliding doors on a refrigerated storage cabinet, comprising:
receiving a signal to open one of multiple sliding doors mounted on tracks within a frame of the refrigerated storage cabinet;
activating a motor of a door opening mechanism joined to the sliding door to be opened, the door opening mechanism comprising:
a linear guide carrying a screw drive operated by the motor;
a door mounting carriage bracket carried by the screw drive and attached to the sliding door;
at least two photometric switches affixed to the linear guide; and
a switch breaker attached to the door mounting carriage bracket;
monitoring door position through communication between a controller and the photometric switches, wherein said monitoring further comprises:
verifying current positions of all sliding doors through the photometric switches prior to initiating movement;
continuously communicating with the photometric switches during door movement; and
halting door movement and signaling an error condition if expected switch breaker engagement is not detected; and
achieving precise positioning through engagement of the switch breaker with the photometric switches.

8. The method of claim 7, further comprising recognizing achievement of a door open state when:
the sliding door reaches a maximum open position;
a distance between the sliding door and an adjacent sliding door is minimized; and
the switch breaker engages one of the photometric switches.

9. The method of claim 7, further comprising recognizing achievement of a door closed state when:
the sliding door returns to a fully closed position;
a distance between the sliding door and an adjacent sliding door is maximized; and
the switch breaker engages one of the photometric switches.

10. The method of claim 7, wherein the door opening mechanisms are mounted alternating between a front side and a back side of a front wall of the refrigerated storage cabinet.

11. The method of claim 7, wherein the sliding doors are positioned intermittently spaced from one another from front to back on the tracks to enable immediately adjacent sliding doors to slide in front of and behind one another.

12. A refrigerated storage system, comprising:
a refrigerated cabinet having a frame and multiple sliding doors mounted on tracks within the frame;
a plurality of door opening mechanisms mounted alternating between a front side and a back side of a front wall of the refrigerated cabinet, each door opening mechanism joined to one of the sliding doors and comprising:
a linear guide carrying a screw drive;
a motor operatively connected to drive the screw drive;
a door mounting carriage bracket carried by the screw drive and attached to one of the sliding doors;
at least two photometric switches affixed to the linear guide; and
a switch breaker attached to the door mounting carriage bracket and positioned to engage the photometric switches; and
a controller configured to coordinate movement of the sliding doors through operation of the door opening mechanisms.

13. The system of claim 12, wherein the sliding doors are positioned intermittently spaced from one another from front to back on the tracks to enable immediately adjacent sliding doors to slide in front of and behind one another.

14. The system of claim 12, wherein the photometric switches are positioned to engage the switch breaker when the attached sliding door is in a fully open position and a fully closed position.

15. The system of claim 12, wherein the controller is configured to recognize achievement of a door open state when:
the sliding door reaches a maximum open position;
a distance between the sliding door and an adjacent sliding door is minimized; and
the switch breaker engages one of the photometric switches.

16. The system of claim 12, wherein the controller is configured to recognize achievement of a door closed state when:
the sliding door returns to a fully closed position;
a distance between the sliding door and an adjacent sliding door is maximized; and
the switch breaker engages one of the photometric switches.

17. The system of claim 12, wherein each door opening mechanism further comprises an upstanding attachment arm on the door mounting carriage bracket for attachment to a bottom portion of one of the sliding doors.

18. The system of claim 12, wherein the photometric switches extend downward from a bottom of the linear guide.

19. The system of claim 19, wherein the screw drive is rotatably mounted at one end to a screw drive receiver.

20. The system of claim 20, wherein the controller is configured to coordinate movement of the sliding doors with movement of a robotic arm retrieving products from within the refrigerated cabinet.
